(19) United States
(12) Patent Application Publication
(10) Pub. No.: US 2015/0252237 A1
(43) Pub. Date: Sep. 10, 2015

(54) Method for Producing Polishing Material Particles

(71) Applicant: KONICA MINOLTA, INC., Chiyoda-ku, Tokyo (JP)

(72) Inventors: Natsuki Ito, Hachioji-shi (JP); Akihiro Maezawa, Hino-shi (JP); Atsushi Takahashi, Musashino-shi (JP); Keisuke Mizoguchi, Hachioji-shi (JP)

(21) Appl. No.: 14/429,713

(22) PCT Filed: Sep. 10, 2013
(86) PCT No.: PCT/JP2013/074379

§ 371 Date: Mar. 19, 2015

(30) Foreign Application Priority Data
Sep. 19, 2012 (JP) 2012-205797

(51) Int. Cl. C09K 3/14; B22F 1/00; B22F 1/02

(52) U.S. Cl. CPC C09K 3/1445; B22F 1/025; B22F 1/0088

(57) ABSTRACT

A method of manufacturing abrasive material particles includes: forming a core layer from an aqueous solution containing a salt of a first element; forming an intermediate layer by adding an aqueous solution containing a salt of a second element and a salt of Ce to the reaction solution; forming a shell layer by adding an aqueous solution containing a salt of Ce to the reaction solution; a solid/liquid separating step; wherein the additions per unit time of the first element, the combination of the second element and Ce, and Ce contained in the aqueous solutions to be added are adjusted so as not to decrease, and the addition of Ce contained in the aqueous solution to be last added in the shell layer forming step is increased compared with the addition of the first element contained in the aqueous solution to be first added in the core layer forming step.

### TECHNICAL FIELD

The present invention relates to methods of manufacturing abrasive material particles.

### BACKGROUND ART

A conventional abrasive material used for performing fine polishing in the process of manufacturing a glass optical element, a glass substrate, or a semiconductor device is an oxide of rare-earth element that contains lanthanum oxide, neodymium oxide, praseodymium oxide, or the like in addition to cerium oxide as the principal component. Other examples of abrasive materials include diamond, iron oxide, aluminum oxide, zirconium oxide, and colloidal silica. However, it is known that cerium oxide is beneficial in terms of the polishing rate and the surface roughness of a target object after polishing, and therefore, cerium oxide is widely used. A problem with cerium oxide is that it is unevenly distributed worldwide, and the supply of cerium oxide is far from stable. In view of this, there is a demand for development of a method of manufacturing abrasive material particles that are capable of polishing with high precision while reducing the usage of cerium oxide.

According to a method of manufacturing a high-purity cerium-oxide abrasive material that is capable of performing fine polishing in the process of manufacturing optical glass, a salt of carbonic acid, oxalic acid, acetic acid, or the like is added to an aqueous solution of purified cerous nitrate, cerous chloride, cerous sulfate, or the like, and the product material such as cerous carbonate, cerous oxalate, or cerous acetate is precipitated. The precipitate is filtered and dried, and is then calcined, to obtain cerium oxide.

For example, Patent Literature 1 discloses a method of obtaining a high-purity abrasive material. This method is a manufacturing method that includes the steps of: successively mixing a cerium nitrate aqueous solution and an ammonia aqueous solution at the same time so that the equivalent number of ammonia becomes equal to or greater than the equivalent number of cerium, and the pH of the reaction medium is higher than 6; filtering and drying the obtained precipitate; calcining the precipitate at 600 to 1200° C.; and subjecting the obtained oxide to jet mill pulverization.

Non-Patent Literature 1 discloses a method of obtaining particles having a narrow particle size distribution by heating and stirring an aqueous solution formed by mixing a cerium nitrate aqueous solution, an yttrium nitrate aqueous solution, and urea.

### CITATION LIST

### Patent Literature

Patent Literature 1: JP 63-27389 A Non-Patent Literature

Non-Patent Literature 1: J. Am. Ceram. Soc., Vol. 71, No. 10, pp. 845-853 (1988)

### SUMMARY OF THE INVENTION

### Technical Problem

In the method disclosed in Patent Literature 1, however, the following aspect is not taken into consideration: in the step of growing the particle size of an abrasive material particle precursor to be dispersed in the reaction solution, the growth rate of the particle size becomes lower as the particle size of the abrasive material particle precursor becomes larger.

Also, particles manufactured by the method disclosed in Non-Patent Literature 1 were calcined, and the effects as an abrasive material were checked. As a result, a low polishing rate was confirmed. The decrease in the polishing rate is supposedly caused by the low cerium density in the particle surfaces, since cerium and another element (yttrium) were uniformly mixed to adjust the particle shape and the particle size distribution.

The present invention has been made in view of the above problems and circumstances, and aims to provide a method of efficiently manufacturing abrasive material particles that reduce the usage of cerium oxide and exhibit higher durability and a higher polishing rate.

### Solution to Problem

To solve the above problems, the invention disclosed in claim 1 is

a method of manufacturing abrasive material particles, the method including:

a core layer forming step of forming a core layer as an abrasive material particle precursor by adding an aqueous solution prepared with a salt of a first element to an aqueous solution prepared with the salt of the first element at a different density, the core layer containing the salt of the first element as the principal component, the first element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals:

an intermediate layer forming step of forming an intermediate layer as an abrasive material particle precursor outside the core layer by adding an aqueous solution prepared with a salt of a second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to the reaction solution having the core layer formed therein and the salt of the first element dispersed therein, the intermediate layer containing the salt of the second element and the salt of Ce;

a shell layer forming step of forming a shell layer as an abrasive material particle precursor outside the intermediate layer by adding an aqueous solution prepared with a salt of Ce to the reaction solution having the intermediate layer formed therein and the salts of the second element and Ce dispersed therein, the shell layer containing the salt of Ce as the principal component;

a solid/liquid separating step of performing solid/liquid separation to separate the abrasive material particle precursor from the reaction solution obtained through the shell layer forming step; and

a calcining step of calcining the abrasive material particle precursor obtained in the solid/liquid separating step in air or an oxidizing atmosphere,

wherein,

in the aqueous solutions from the aqueous solution to be first added in the core layer forming step to the aqueous solution to be last added in the shell layer forming step, the addition per unit time of the first element contained in the aqueous solution to be added in the core layer forming step, the total addition per unit time of the second element and Ce contained in the aqueous solution to be added in the intermediate layer forming step, and the addition per unit time of Ce contained in the aqueous solution to be added in the shell layer forming step are adjusted so as not to decrease, and

the addition of Ce contained in the aqueous solution to be last added in the shell layer forming step is increased compared with the addition of the first element contained in the aqueous solution to be first added in the core layer forming step.

The invention disclosed in claim 2 is the method of manufacturing abrasive material particle of claim 1, characterized in that, in the aqueous solutions to be added at least in one step of the core layer forming step, the intermediate layer forming step, and the shell layer forming step, the total addition of additive elements contained in the aqueous solution to be last added in the one step is increased compared with the total addition of additive elements contained in the aqueous solution to be first added in the one step.

The invention disclosed in claim 3 is the method of manufacturing abrasive material particle of claim 1 or 2, characterized in that the total addition of the second element and Ce contained in the aqueous solution to be first added in the intermediate layer forming step is increased compared with the addition of the first element contained in the aqueous solution to be last added in the core layer forming step.

The invention disclosed in claim 4 is the method of manufacturing abrasive material particle of claim 1 or 2, characterized in that the addition of Ce contained in the aqueous solution to be first added in the shell layer forming step is increased compared with the total addition of the second element and Ce contained in the aqueous solution to be last added in the intermediate layer forming step.

The invention disclosed in claim 5 is the method of manufacturing abrasive material particle of one of claims 1 to 4, characterized in that the total addition per unit time of additive elements contained in the aqueous solutions to be added in at least one step of the core layer forming step, the intermediate layer forming step, and the shell layer forming step is increased as the reaction time passes.

The invention disclosed in claim 6 is the method of manufacturing abrasive material particle of one of claims 1 to 5, characterized in that the addition per unit time of the first element contained in the aqueous solution to the added in the core layer forming step, the total addition per unit time of the second element and Ce contained in the aqueous solution to be added in the intermediate layer forming step, and the addition per unit time of Ce contained in the aqueous solution to be added in the shell layer forming step are adjusted in accordance with densities or addition rates of the respective aqueous solutions.

The invention disclosed in claim 7 is

a method of manufacturing abrasive material particles, the method including:

an inner layer forming step of forming an inner layer as an abrasive material particle precursor by adding an aqueous solution prepared with a salt of a first element to an aqueous solution prepared with the salt of the first element at a different density, the inner layer containing the salt of the first element as the principal component, the first element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals:

an outer layer forming step of forming an outer layer as an abrasive material particle precursor outside the inner layer by adding an aqueous solution prepared with a salt of a second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to the reaction solution having the inner layer formed therein and the salt of the first element dispersed therein, the outer layer containing the salt of the second element and the salt of Ce;

a solid/liquid separating step of performing solid/liquid separation to separate the abrasive material particle precursor from the reaction solution obtained through the outer layer forming step; and

a calcining step of calcining the abrasive material particle precursor obtained in the solid/liquid separating step in air or an oxidizing atmosphere,

wherein,

in the aqueous solutions from the aqueous solution to be first added in the inner layer forming step to the aqueous solution to be last added in the outer layer forming step, the addition per unit time of the first element contained in the aqueous solution to be added in the inner layer forming step and the total addition per unit time of the second element and Ce contained in the aqueous solution to be added in the outer layer forming step are adjusted so as not to decrease, and

the total addition of the second element and Ce contained in the aqueous solution to be last added in the outer layer forming step is increased compared with the addition of the first element contained in the aqueous solution to be first added in the inner layer forming step.

The invention disclosed in claim 8 is

a method of manufacturing abrasive material particles, the method including:

an inner layer forming step of forming an inner layer as an abrasive material particle precursor by adding an aqueous solution prepared with a salt of an element and a salt of Ce to an aqueous solution prepared with the salt of the element and the salt of Ce at a different density, the inner layer containing the salt of the element and the salt of Ce, the element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals;

an outer layer forming step of forming an outer layer as an abrasive material particle precursor outside the inner layer by adding an aqueous solution prepared with a salt of Ce to the reaction solution having the inner layer formed therein and the salts of the element and Ce dispersed therein, the outer layer containing the salt of Ce as the principal component;

a solid/liquid separating step of performing solid/liquid separation to separate the abrasive material particle precursor from the reaction solution obtained through the outer layer forming step; and

a calcining step of calcining the abrasive material particle precursor obtained in the solid/liquid separating step in air or an oxidizing atmosphere,

wherein,

in the aqueous solutions from the aqueous solution to be first added in the inner layer forming step to the aqueous solution to be last added in the outer layer forming step, the total addition per unit time of the element and Ce contained in the aqueous solution to be added in the inner layer forming step and the addition per unit time of Ce contained in the aqueous solution to be added in the outer layer forming step are adjusted so as not to decrease, and

the addition of Ce contained in the aqueous solution to be last added in the outer layer forming step is increased compared with the total addition of the element and Ce contained in the aqueous solution to be first added in the inner layer forming step.

### Advantageous Effects of Invention

According to the present invention, abrasive material particles that reduce the usage of cerium oxide and exhibit higher durability and a higher polishing rate can be efficiently manufactured.

### BRIEF DESCRIPTION OF DRAWINGS

FIG. 1A is a diagram schematically showing the structure of an abrasive material particle as an embodiment according to the present invention.

FIG. 1B is a diagram schematically showing the structure of an abrasive material particle as an embodiment according to the present invention.

FIG. 1C is a diagram schematically showing the structure of an abrasive material particle as an embodiment according to the present invention.

FIG. 2 is a diagram schematically showing the flow in the process of manufacturing abrasive material particles as an embodiment according to the present invention.

FIG. 3A is a diagram schematically showing a variation in the addition per unit time of an additive element contained in an aqueous solution to be added in a process of manufacturing abrasive material particles as an embodiment according to the present invention.

FIG. 3B is a diagram schematically showing a variation in the addition per unit time of an additive element contained in an aqueous solution to be added in a process of manufacturing abrasive material particles as an embodiment according to the present invention.

FIG. 3C is a diagram schematically showing a variation in the addition per unit time of an additive element contained in an aqueous solution to be added in a process of manufacturing abrasive material particles as an embodiment according to the present invention.

### DESCRIPTION OF EMBODIMENTS

The following is a detailed description of existing abrasive materials and a method of manufacturing abrasive material particles according to the present invention.

<Abrasive Materials>

A general abrasive material is a slurry-like material formed by dispersing particles of an abrasive material, such as red iron oxide (αFe₂O₃), cerium oxide, aluminum oxide, manganese oxide, zirconium oxide, or colloidal silica, in water or oil. The present invention relates to a method of manufacturing novel abrasive material particles to be used in an abrasive material containing cerium oxide as the principal component that is capable of chemical mechanical polishing (CMP) for performing polishing both physically and chemically so as to achieve a sufficient polishing rate while maintaining flatness with high precision in a polishing process for a semiconductor device or glass. This will be described below in detail.

<Structure of an Abrasive Material Particle>

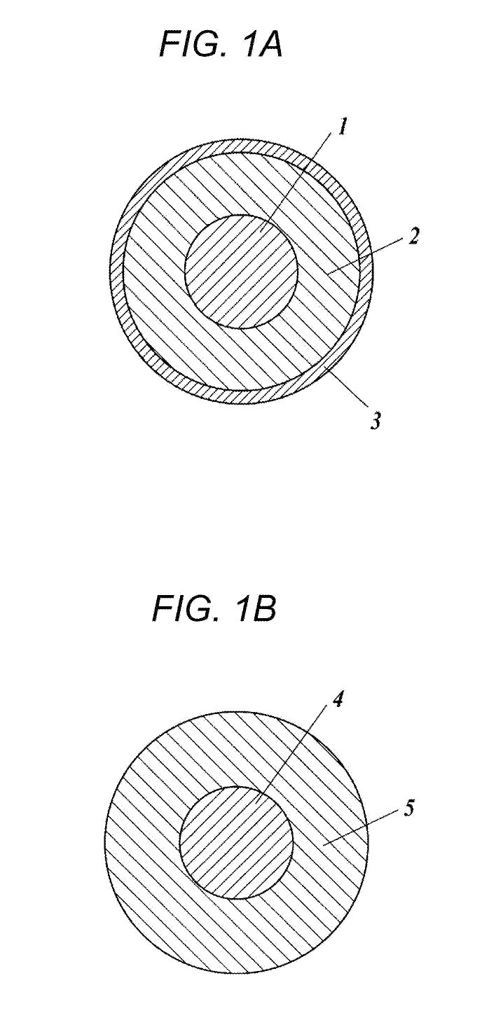

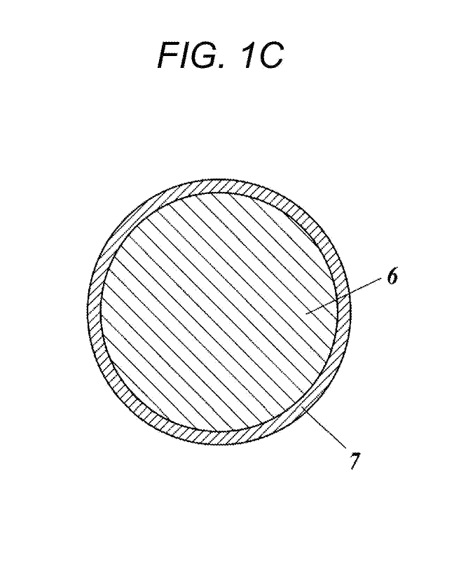

An abrasive material particle according to the present invention is preferably a three-layer abrasive material particle including a core layer 1, an intermediate layer 2, and a shell layer 3. Specifically, as shown in FIG. 1A, the three-layer abrasive material particle includes: the core layer 1 that contains a salt of a first element as the principal component that is at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, such as yttrium oxide; the intermediate layer 2 that is formed outside the core layer 1 and contains a salt of a second element as the principal component that is at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, such as yttrium oxide and cerium oxide; and the shell layer 3 that is formed outside the intermediate layer 2 and contains cerium oxide as the principal component. Here, each of the first and second elements is at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and is not particularly limited. In the description below, however, each of the first and second elements is yttrium (Y). Selecting the same element as the first and second elements is preferable in that the layers in the abrasive material particle are continuously formed, but the first and second elements are not necessarily the same element.

The salt of the first element that is at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, such as yttrium oxide, accounts for almost 100 mol % of the core layer 1, and the core layer 1 hardly contains cerium oxide. This is because the salt of the first element such as yttrium oxide is more unlikely than cerium oxide to be broken by the stress applied during polishing, for example.

The intermediate layer 2 contains yttrium oxide and cerium oxide as the salt of the second element that is at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals.

The shell layer 3 is formed outside the intermediate layer 2, and contains almost 100 mol % of cerium oxide. Specifically, the proportion of cerium oxide in the shell layer 3 is preferably 50 to 100 mol %, or more preferably, 75 mol % or higher. This is because cerium oxide can contribute to an excellent polishing rate if the density of the cerium oxide in the shell layer 3 serving as the surface of the abrasive material particle is adjusted to almost 100 mol %. So as to maintain the binding force between the layers, the element contained as the principal component in the core layer 1 of the abrasive material particle is preferably an oxide of at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and is preferably the same as the oxide of an element contained in the intermediate layer 2. However, the element contained as the principal component in the core layer 1 is not limited to the above. For example, the core layer 1 may contain a different oxide of at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, from the oxide of an element contained in the intermediate layer 2.

Although the above described abrasive material particles has a three-layer structure including the core layer 1, the intermediate layer 2, and the shell layer 3, the abrasive material particle may have a two-layer structure that does not include the shell layer 3. Specifically, as shown in FIG. 1B, such an abrasive material particle has a two-layer structure that includes an inner layer 4 and an outer layer 5 formed outside the inner layer 4. In this two-layer structure, the constituent element of the inner layer 4 is equivalent to the core layer 1 of the three-layer structure, and the constituent element of the outer layer 5 is equivalent to the intermediate layer 2 of the three-layer structure. That is, in the case of the two-layer structure that does not include the shell layer 3, the inner layer 4 includes a layer containing a salt of the first element as the principal component, and the outer layer 5 includes a layer containing a salt of the second element and cerium oxide. Accordingly, the density of cerium oxide in the surface of the abrasive material particle is higher than that in an abrasive material particle that does not have a layer structure formed by uniformly mixing the same amounts of a salt of the first element, a salt of the second element, and cerium oxide. Thus, the abrasive material particle having the two-layer structure of the inner layer 4 and the outer layer 5 can achieve a higher polishing rate than an abrasive material particle formed by uniformly mixing cerium oxide and a salt of some other element.

Alternatively, the abrasive material particle may have a two-layer structure that does not include the core layer 1. Specifically, as shown in FIG. 1C, the abrasive material may have a two-layer structure that includes an inner layer 6 including the center of the abrasive material particle, and an outer layer 7 formed outside the inner layer 6. In this two-layer structure, the constituent element of the inner layer 6 is equivalent to the intermediate layer 2 of the three-layer structure, and the constituent element of the outer layer 7 is equivalent to the shell layer 3 of the three-layer structure. That is, in the case of the two-layer structure that does not include the core layer 1, the inner layer 6 includes the center of the abrasive material particle and a layer containing a salt of at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals (hereinafter referred to as the salt of the second element) and a salt of cerium oxide, and the outer layer 7 includes a layer containing cerium oxide as the principal component. Accordingly, in the case of the two-layer structure that does not include the core layer 1, the density of cerium oxide in the surface of the abrasive material particle is also higher than that in an abrasive material particle that does not have a layer structure formed by uniformly mixing the same amounts of the salt of the second element and cerium oxide . Thus, the abrasive material particle having the two-layer structure of the inner layer 6 and the outer layer 7 can achieve a higher polishing rate than an abrasive material particle formed by uniformly mixing cerium oxide and a salt of some other element. Also, like the abrasive material particle having the three-layer structure, these abrasive material particles each having a two-layer structure contains the first or second salt that is resistant to the pressure applied during polishing. Accordingly, the usage of cerium oxide can be made smaller, and higher durability can be achieved, compared with an abrasive material particle formed only with cerium oxide.

In the description below, the inner layer 4 is equivalent to the core layer 1, the outer layer 5 is equivalent to the intermediate layer 2, the inner layer 6 is equivalent to the intermediate layer 2, and the outer layer 7 is equivalent to the shell layer 3. Also, the steps of forming the inner layer 4, the outer layer 5, the inner layer 6, and the outer layer 7 are the same as the steps of forming the respective equivalent layers, and therefore, detailed explanation of them will not be made below.

<Method of Manufacturing Abrasive Material Particles>

A method of manufacturing abrasive material particles having the three-layer structure formed with the core layer 1, the intermediate layer 2, and the shell layer 3 as shown in FIG. 1A is described below.

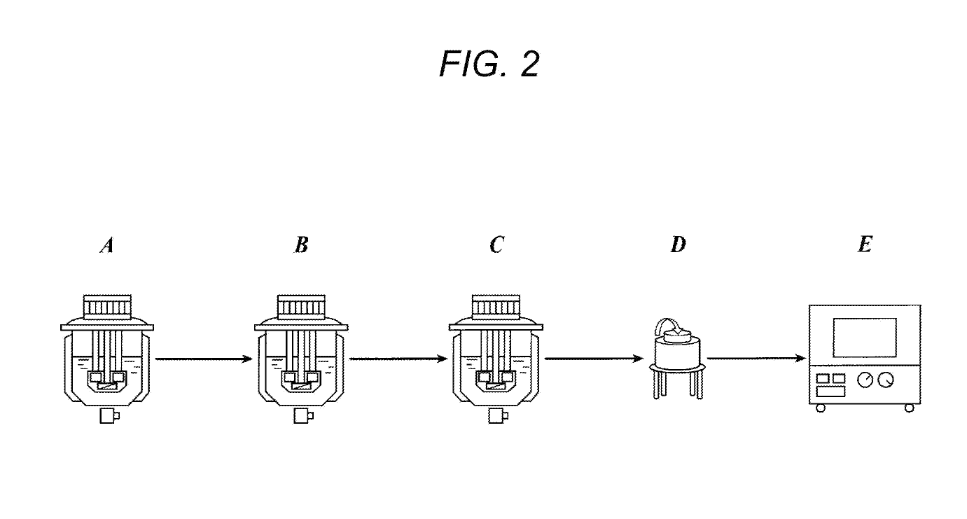

As shown in FIG. 2, the method of manufacturing abrasive material particles according to the present invention includes the five steps of a core layer forming step A, an intermediate layer forming step B, a shell layer forming step C, a solid/liquid separating step D, and a calcining step E.

1. Core Layer Forming Step A

In the core layer forming step A, the core layer 1 that contains the salt of the first element as the principal component and serves as an abrasive material particle precursor is formed by adding an aqueous solution prepared with the salt of the first element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, to an aqueous solution prepared with the salt of the first element at a different density. For example, in the core layer forming step A, a precipitant is added to an aqueous solution prepared with yttrium nitrate, another aqueous solution prepared with yttrium nitrate at a different density is further added to the solution, and the resultant solution is heated and stirred at 80° C. or higher. In this manner, a basic carbonate that forms the core layer 1 as an abrasive material particle precursor and is insoluble in water is formed in the core layer forming step A. In the description below, the solution with which the heating and stirring is started will be referred to as the reaction solution.

In the core layer forming step A, nitrate, hydrochloride, sulfate, or the like can be used as the salt of the first element in preparing the aqueous solutions, but it is preferable to use nitrate that restricts impurities in the product to a small amount. The precipitant is an alkali compound of a kind that generates a basic carbonate when mixed with the salt of the first element in water and then heated, and is preferably a urea compound, ammonium carbonate, ammonium hydrogen carbonate, or the like. Examples of urea compounds include urea salts (such as nitrate or hydrochloride), N,N′-dimethylacetylurea, N,N′-dibenzoylurea, benzenesulphonylurea, p-toluenesulfonylurea, trimethylurea, tetraethylurea, tetramethylurea, triphenylurea, tetraphenylurea, N-benzoylurea, methylisourea, and ethylisourea, as well as urea. Of these urea compounds, urea is particularly preferable in that a precipitate is slowly generated as hydrolysis gradually progresses, and uniform precipitation is achieved. Also, a basic carbonate that is insoluble in water, such as a basic carbonate of yttrium, is generated so that the separated precipitate can be dispersed in a monodispersed state. Furthermore, a basic carbonate of cerium will be formed in each of the intermediate layer forming step B and the shell layer forming step C, which will be described later. Accordingly, a continuous layer structure of basic carbonates can be formed. Although yttrium nitrate is used as the salt of the first element for preparing the aqueous solution to be added to the reaction solution, and the urea is used as the urea compound in the above described core layer forming step A, this is merely an example, and the present invention is not limited to this example.

The increase rate of the density of yttrium in the reaction solution in the core layer forming step A is preferably 0.003 to 5.5 mmol/L per minute, and an aqueous solution containing yttrium is preferably added to the reaction solution while the reaction solution is being heated and stirred at 80° C. or higher. This is because, with the density in the reaction solution falling within the above range, circular abrasive material particles that excel in monodispersity can be readily formed. The heating temperature is set as above, because the added urea is easily decomposed when the heating and stirring is performed at 80° C. or higher. The density of the urea to be added is preferably 5 to 50 times higher than the yttrium ion density. This is because, with the yttrium ion density in the aqueous solution and the urea density falling within the above ranges, circular abrasive material particles having monodispersity can be synthesized.

At the time of heating and stirring, the shape of the stirrer is not particularly limited, as long as a sufficient stirring effect is achieved. However, so as to achieve a greater stirring effect, it is preferable to use an axial-flow stirrer of a rotor/stator type.

2. Intermediate Layer Forming Step B

In the intermediate layer forming step B, the intermediate layer 2 as an abrasive material particle precursor containing the salt of the second element and a salt of Ce is formed outside the core layer 1 by adding an aqueous solution prepared with the salt of the second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to the reaction solution having the core layer 1 formed therein and the salt of the first element dispersed therein. Specifically, in the intermediate layer forming step B, the intermediate layer 2 containing a basic carbonate of yttrium and a basic carbonate of cerium is formed outside the core layer 1 by adding an aqueous solution prepared with yttrium nitrate and cerium nitrate to the reaction solution that has been formed in the core layer forming step A and has a basic carbonate of yttrium dispersed therein. In this example case, yttrium nitrate and cerium nitrate are used as the salt of yttrium and the salt of cerium in preparing the aqueous solution, because it is preferable to use nitrate that restricts impurities in the product to a small amount. However, the present invention is not limited to this case, and it is also possible to use hydrochloride, sulfate, or the like.

The increase rate of the total density of yttrium and cerium in the reaction solution in the intermediate layer forming step B is preferably 0.003 to 5.5 mmol/L per minute. This is because, with the density in the reaction solution falling within the above range, circular abrasive material particles that excel in monodispersity can be readily formed. Also, the proportion of the density of cerium in the aqueous solution to be added is preferably 90 mol % or lower. This is because, if the proportion of the density of cerium in the aqueous solution to be added is higher than 90 mol %, the resultant abrasive material particles do not exhibit monodispersity but aggregate in a plate-like form after the adding is performed for the same period of time as that in a case where an aqueous solution prepared with 90 mol % or less of cerium. Meanwhile, the reaction solution is preferably heated and stirred at 80° C. or higher while the aqueous solution is being added thereto. This is because the heating and stirring at 80° C. or higher facilitates the decomposition of the urea added in the core layer forming step A.

3. Shell Layer Forming Step C

The shell layer 3 as an abrasive material particle precursor containing a salt of Ce as the principal component is formed outside the intermediate layer 2 by adding an aqueous solution prepared with a salt of Ce to the reaction solution that has the intermediate layer 2 formed therein and the salts of the second element and Ce dispersed therein through the intermediate layer forming step B. For example, the shell layer 3 containing a basic carbonate of cerium as the principal component is formed outside the intermediate layer 2 by adding an aqueous solution prepared with cerium nitrate to the reaction solution that has the intermediate layer 2 formed therein and basic carbonates of yttrium and cerium dispersed therein.

The increase rate of the density of cerium in the reaction solution in the shell layer forming step C is preferably 0.003 to 3.0 mmol/L per minute, and the adding is performed while the reaction solution is being heated and stirred at 80° C. or higher. This is because, with the density in the reaction solution falling within the above range, circular abrasive material particles that excel in monodispersity can be readily formed as in the core layer forming step A and the intermediate layer forming step B. As for the temperature for heating the reaction solution, the reaction solution is preferably heated and stirred at 80° C. or higher as in the intermediate layer forming step B. This is because the heating and stirring at 80° C. or higher facilitates the decomposition of the urea added in the core layer forming step A.

The aqueous solutions to be added in the core layer forming step A, the intermediate layer forming step B, and the shell layer forming step C are now described.

As for the aqueous solutions from the aqueous solution to be first added in the core layer forming step A to the aqueous solution to be last added in the shell layer forming step C, the addition per unit time of the first element contained in the aqueous solution to be added in the core layer forming step A, the total addition per unit time of the second element and Ce contained in the aqueous solution to be added in the intermediate layer forming step B, and the addition per unit time of Ce contained in the aqueous solution to be added in the shell layer forming step C are adjusted so as not to decrease. The addition of cerium contained in the aqueous solution to be last added in the shell layer forming step C is increased compared with the addition of the first element contained in the aqueous solution to be first added in the core layer forming step A. Accordingly, the usage of cerium oxide can be restricted, and higher durability and a higher polishing rate can be more efficiently achieved, while the growth rate of the particle size of the abrasive material particles is controlled in accordance with the particle size of the target abrasive material particles.

Specifically, the aqueous solution to be added in at least one of the core layer forming step A, the intermediate layer forming step B, and the shell layer forming step C can be prepared in accordance with at least one of the following methods: I. increase in one step, II. increase between steps, and III. temporal increase. Also, the addition per unit time of the first element contained in the aqueous solution to be added in the core layer forming step A, the total addition per unit time of the second element and Ce contained in the aqueous solution to be added in the intermediate layer forming step B, and the addition per unit time of Ce contained in the aqueous solution to be added in the shell layer forming step C can be prepared in accordance with the densities or the addition rates of the respective aqueous solutions. In the description below, yttrium is used as the first element contained in the aqueous solution to be added in the core layer forming step A and as the second element contained in the aqueous solution to be added in the intermediate layer forming step B.

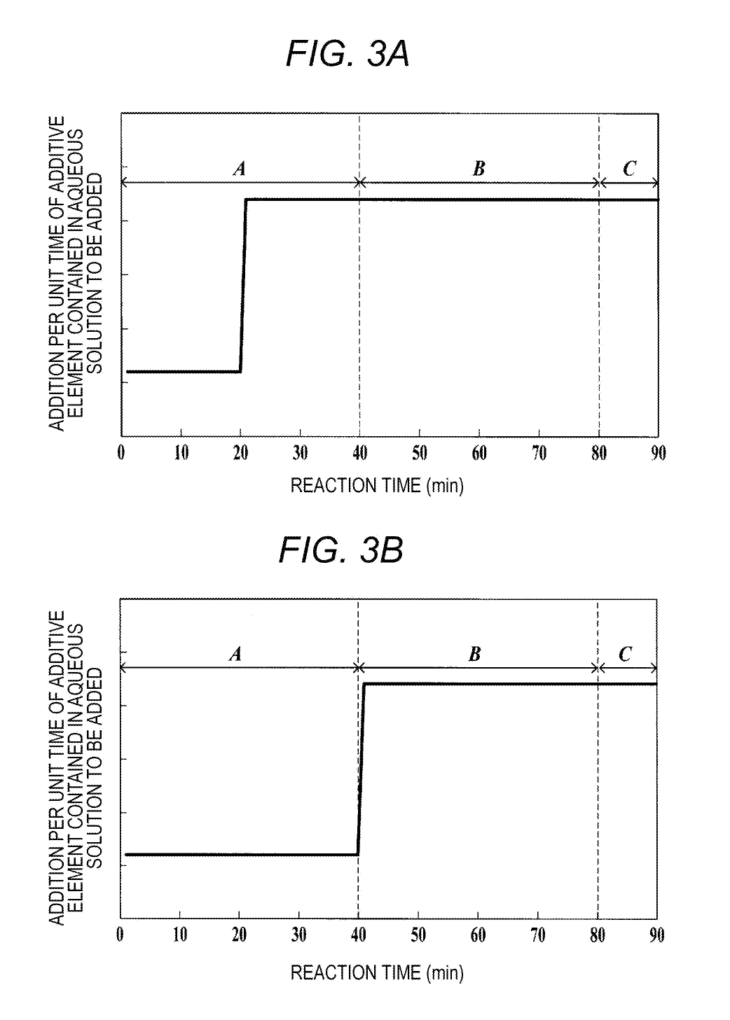

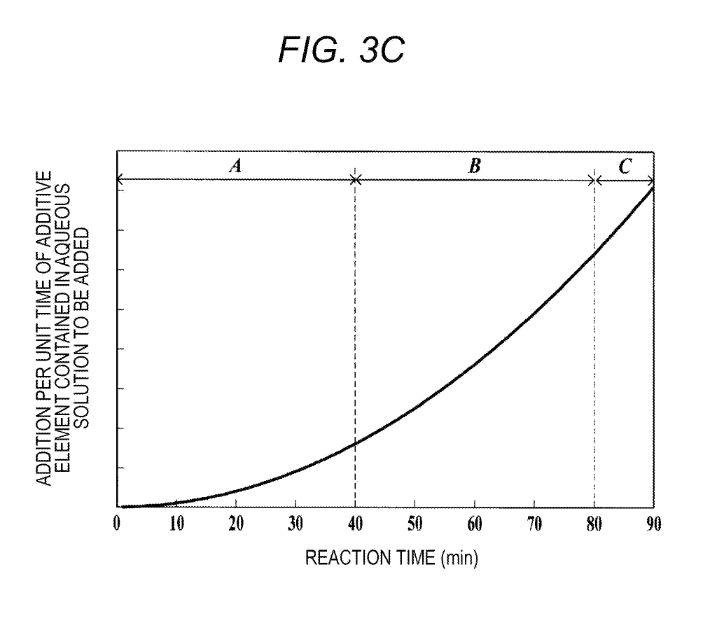

In the case of I. increase in one step, as for the aqueous solutions to be added in at least one of the core layer forming step A, the intermediate layer forming step B, and the shell layer forming step C, the total addition of the additive elements contained in the aqueous solution to be last added in the one step is increased compared with the total addition of the additive elements contained in the aqueous solution to be first added in the one step. Here, the total addition of the additive elements contained in an aqueous solution is the total addition of elements contained in the aqueous solution to be added in each step. That is, the total addition of additive elements contained in the aqueous solution is the addition of yttrium contained in the aqueous solution in the core layer forming step A, is the total addition of yttrium and cerium contained in the aqueous solution in the intermediate layer forming step B, and is the addition of cerium contained in the aqueous solution in the shell layer forming step C. Specifically, in a case where an aqueous solution containing yttrium is added in the core layer forming step A, the addition of yttrium contained in the aqueous solution to be added at the end of the core layer forming step A is increased compared with the addition of yttrium contained in the aqueous solution to be first added immediately after the start of the reaction. For example, as shown in FIG. 3A, the addition of the additive element contained in the aqueous solution may be increased by increasing the addition per unit time of yttrium contained in the aqueous solution to be added in the latter half of the core layer forming step A, compared with the addition per unit time of yttrium contained in the aqueous solution to be added in the first half of the core layer forming step A. With this, an abrasive material particle precursor can be obtained while the growth rate of the particle size of the abrasive material particles is controlled in accordance with the particle size of the target abrasive material particles or the like. Although the densities in the aqueous solutions to be added in the core layer forming step A are divided into the two stages of the first half and the second half, this is merely an example, and can be applied to the aqueous solutions to be added in the intermediate layer forming step B and the shell layer forming step C. Furthermore, the densities may be increased in three or more stages.

In the case of II. increase between steps, the total addition of the second element and Ce contained in the aqueous solution to be first added in the intermediate layer forming step B is increased compared with the addition of the first element contained in the aqueous solution to be last added in the core layer forming step A. Specifically, the total addition of yttrium and cerium contained in the aqueous solution to be first added in the intermediate layer forming step B is increased compared with the addition of yttrium contained in the aqueous solution to be last added in the core layer forming step A. For example, as shown in FIG. 3B, the total addition of the additive elements contained in the aqueous solution to be added is increased at the time of the transition from the core layer forming step A to the intermediate layer forming step B. With this, the abrasive material particle precursor that has grown to a predetermined particle size through the core layer forming step A can be more efficiently grown as particles in the intermediate layer forming step B.

In the case of II. increase between steps, the addition of Ce contained in the aqueous solution to be first added in the shell layer forming step C may be increased compared with the total addition of the second element and Ce contained in the aqueous solution to be last added in the intermediate layer forming step B. For example, the addition of cerium contained in the aqueous solution to be added in the shell layer forming step C is increased compared with the total addition of yttrium and cerium contained in the aqueous solution to be last added in the intermediate layer forming step B. With this, the abrasive material particle precursor that has grown to a predetermined particle size through the intermediate layer forming step B can be more efficiently grown as particles in the shell layer forming step C. The adding of aqueous solutions in accordance with an increase between steps may be performed between two of the steps or between every two of the steps. Also, the layer that has a density or an addition rate to be adjusted can be appropriately changed in accordance with the thicknesses of the respective layers in the target abrasive material particles or the like.

In the case of III. temporal increase, the total addition per unit time of the additive elements contained in the aqueous solutions to be added in at least one of the core layer forming step A, the intermediate layer forming step B, and the shell layer forming step C is increased with the reaction time. For example, as shown in FIG. 3C, the total addition per unit time of the additive elements contained in the aqueous solutions to be added from the core layer forming step A to the end of the reaction in the shell layer forming step C through the intermediate layer forming step B is quadratically increased with the reaction time. With this, the reaction can be made to progress slowly, and the particle size that becomes larger with the reaction time can be efficiently grown. The quadratic increase shown in FIG. 3C is merely an example, and the present invention is not limited to this example. The increase may be an increase that changes with the reaction time, and may be a linear increase, an exponential increase, or a logarithmic increase, for example. Also, the addition per unit time that is to be adjusted in accordance with the density or the like of the aqueous solution to be added in at least one of the core layer forming step A, the intermediate layer forming step B, and the shell layer forming step C increases with the reaction time. As shown in FIG. 3C, the growth rate of the particle size can be controlled in a more minute manner by increasing the additions per unit time of the aqueous solutions with time in all the steps of the core layer forming step A, the intermediate layer forming step B, and the shell layer forming step C.

An increase in a step, an increase between steps, and a temporal increase of an addition per unit time in accordance with the density or the like of an aqueous solution may also be used in the steps of manufacturing abrasive material particles having the two-layer structure formed with the inner layer 4 and the outer layer 5 or the two-layer structure formed with the inner layer 6 and the outer layer 7. In that case, the same effects as above can be achieved.

4. Solid/Liquid Separating Step D

In the solid/liquid separating step D, solid/liquid separation is performed to separate the abrasive material particle precursor from the reaction solution obtained through the shell layer forming step C. In the solid/liquid separating step D, the obtained abrasive material particle precursor is dried, if necessary. After that, the calcining step E may be started.

5. Calcining Step E

The abrasive material particle precursor obtained through the solid/liquid separating step D is calcined in air or an oxidizing atmosphere at 300° C. or higher. Through the calcination, carbon dioxide is removed from the abrasive material particle precursor. As a result, the precursor turns from a basic carbonate into an oxide, and the target abrasive material particles are obtained.

<Particle Size, Polishing Rate, and Surface Accuracy of the Abrasive Material Particles>

Various levels of demands with respect to the particle size of abrasive material particles are made in accordance with purposes of use. As the finished surface accuracy after polishing becomes higher, the abrasive material particles contained in the abrasive material being used should be turned into finer particles. For example, to be used in the process of manufacturing a semiconductor device, the mean particle size needs to be 2.0 μm or smaller. As the particle size of the polishing material becomes smaller, the finished surface accuracy after polishing tends to become higher. On the other hand, as the particle size becomes smaller, the polishing rate tends to become lower. Therefore, if the particle size is smaller than 0.02 μm, the advantage that the polishing rate of a cerium-based abrasive material is higher than that of an abrasive material such as colloidal silica is not achieved. In view of this, the mean particle size of the abrasive material particles is preferably 0.02 to 2.0 μm, and more preferably, 0.05 to 1.5 μm.

Also, so as to increase the plane accuracy after a polishing process, the particle sizes in the abrasive material to be used are as uniform as possible, and the variation coefficient of the particle size distribution is preferably small.

<Method of Using the Abrasive Material and Degradation of the Abrasive Material>

A method of using the abrasive material is now described, with a glass substrate polishing process being taken as an example.

1. Preparation of Abrasive Material Slurry

Abrasive material slurry is produced by adding powder of an abrasive material using the abrasive material particles to a solvent such as water. Aggregation is prevented by adding a dispersant or the like to the abrasive material slurry, and a dispersed state is maintained by constantly stirring the slurry with a stirrer or the like. The abrasive material slurry is supplied to a polishing machine in a circulating manner with a supply pump.

2. Polishing Step

A glass substrate is brought into contact with the upper and lower surface plates of the polishing machine to which abrasive pads (abrasive cloth) are bonded, and the pads and the glass are moved relative to each other under pressure while the abrasive material slurry is being supplied to the contact surfaces. In this manner, polishing is performed.

3. Degradation of the Abrasive Material

The abrasive material is used under a pressurized condition in the polishing step as described above. Therefore, the abrasive material particles contained in the abrasive material gradually break down and become smaller as the polishing time passes. Smaller abrasive material particles cause a decrease in the polishing rate. Therefore, abrasive material particles that have a small particle size distribution before and after polishing are desirable.

### EXAMPLES

Specific examples will be described below as Examples and Comparative Examples, but the present invention is not limited to them.

### Abrasive Material 1: Example 1

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.05 mol/L in density was added to the reaction solution obtained in the above step 1) at an addition rate of S mL/min (S=0.01×t₁² (t₁ being the total addition time (min), 0 being the start of the addition of the yttrium nitrate aqueous solution) for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 0.05 mol/L was added to the reaction solution obtained in the above step 2) at an addition rate of S mL/min (S=0.01×t₁²) for 40 minutes, while the reaction solution was being heated and stirred at 90° C. In the step 3), t₁ started from 41 minutes at which the above step 2) ended.

4) A cerium nitrate aqueous solution of 0.05 mol/L in density was added to the reaction solution obtained in the above step 3) at an addition rate of S mL/min (S=0.01×t₁²) for 10 minutes, while the reaction solution was being heated and stirred at 90° C. In the step 4), t₁ started from 81 minutes at which the above step 3) ended.

5) The precipitated abrasive material particle precursor was separated from the reaction solution obtained in the above step 4) with a membrane filter, and was then calcined at 600° C. As a result, abrasive material particles were obtained.

### Abrasive Material 2: Example 2

1) Two liters of 0.02 mol/L yttrium nitrate aqueous solution were prepared, and urea was added to this aqueous solution so that the density of the urea became 0.60 mol/L. After sufficiently stirred, the resultant solution was heated and stirred at 90° C.

2) An yttrium nitrate aqueous solution of C mol/L (C=0.0005×t₂² (t₂ being the total addition time (min), 0 being the start of the addition of the yttrium nitrate aqueous solution) in density was added to the reaction solution obtained in the above step 1) at an addition rate of 1 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of C mol/L (C=0.0005×t₂²) was added to the reaction solution obtained in the above step 2) at an addition rate of 1 mL/min for 40 minutes, while the reaction solution was being heated and stirred at 90° C. In the step 3), t₂ started from 41 minutes at which the above step 2) ended.

4) A cerium nitrate aqueous solution of C mol/L (C=0.0005×t₂²) in density was added to the reaction solution obtained in the above step 3) at an addition rate of 1 mL/min for 10 minutes, while the reaction solution was being heated and stirred at 90° C. In the step 4), t₂ started from 81 minutes at which the above step 3) ended.

5) The precipitated abrasive material particle precursor was separated from the reaction solution obtained in the above step 4) with a membrane filter, and was then calcined at 600° C. As a result, abrasive material particles were obtained.

### Abrasive Material 3: Example 3

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.13 mol/L in density was added to the reaction solution obtained in the above step 1) at an addition rate of 1 mL/min for 20 minutes, an yttrium nitrate aqueous solution of 0.5 mol/L in density was added to the reaction solution at an addition rate of 1 mL/min for 10 minutes, and an yttrium nitrate aqueous solution of 0.8 mol/L in density was added to the reaction solution at an addition rate of 1 mL/min for 10 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.3 mol/L was added to the reaction solution obtained in the above step 2) at an addition rate of 1 mL/min for 10 minutes, a mixed solution of 2.1 mol/L in total density was added to the reaction solution at an addition rate of 1 mL/min for 20 minutes, and the mixed solution of 3.2 mol/L in total density was added to the reaction solution at an addition rate of 1 mL/min for 10 minutes, while the reaction solution was being heated and stirred at 90° C.

4) A cerium nitrate aqueous solution of 3.4 mol/L in density was added to the reaction solution obtained in the above step 3) at an addition rate of 1 mL/min for five minutes, and a cerium nitrate aqueous solution of 3.9 mol/L in density was added to the reaction solution at an addition rate of 1 mL/min for five minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 4: Example 4

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.13 mol/L in density was added to the reaction solution obtained in the above step 1) at an addition rate of 1 mL/min for 20 minutes, and an yttrium nitrate aqueous solution of 0.63 mol/L in density was added to the reaction solution at an addition rate of 1 mL/min for 20 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.5 mol/L was added to the reaction solution obtained in the above step 2) at an addition rate of 1 mL/min for 20 minutes, and the mixed solution of 2.8 mol/L in total density was added to the reaction solution at an addition rate of 1 mL/min for 20 minutes, while the reaction solution was being heated and stirred at 90° C.

4) A cerium nitrate aqueous solution of 3.4 mol/L in density was added to the reaction solution obtained in the above step 3) at an addition rate of 1 mL/min for five minutes, and a cerium nitrate aqueous solution of 3.9 mol/L in density was added to the reaction solution at an addition rate of 1 mL/min for five minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 5: Example 5

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.13 mol/L in density was added to the reaction solution obtained in the above step 1) at an addition rate of 1 mL/min for 20 minutes, and an yttrium nitrate aqueous solution of 0.63 mol/L in density was added to the reaction solution at an addition rate of 1 mL/min for 20 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.5 mol/L was added to the reaction solution obtained in the above step 2) at an addition rate of 1 mL/min for 20 minutes, and the mixed solution of 2.8 mol/L in total density was added to the reaction solution at an addition rate of 1 mL/min for 20 minutes, while the reaction solution was being heated and stirred at 90° C.

4) A cerium nitrate aqueous solution of 3.7 mol/L in density was added to the reaction solution obtained in the above step 3) at an addition rate of 1 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 6: Example 6

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.13 mol/L in density was added to the reaction solution obtained in the above step 1) at an addition rate of 1 mL/min for 20 minutes, and an yttrium nitrate aqueous solution of 0.63 mol/L in density was added to the reaction solution at an addition rate of 1 mL/min for 20 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 2.2 mol/L was added to the reaction solution obtained in the above step 2) at an addition rate of 1 mL/min for 40 minutes, while the reaction solution was being heated and stirred at 90° C.

4) A cerium nitrate aqueous solution of 3.4 mol/L in density was added to the reaction solution obtained in the above step 3) at an addition rate of 1 mL/min for five minutes, and a cerium nitrate aqueous solution of 3.9 mol/L in density was added to the reaction solution at an addition rate of 1 mL/min for five minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 7: Example 7

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.4 mol/L in density was added to the reaction solution obtained in the above step 1) at an addition rate of 1 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.5 mol/L was added to the reaction solution obtained in the above step 2) at an addition rate of 1 mL/min for 20 minutes, and the mixed solution of 2.8 mol/L in total density was added to the reaction solution at an addition rate of 1 mL/min for 20 minutes, while the reaction solution was being heated and stirred at 90° C.

4) A cerium nitrate aqueous solution of 3.4 mol/L in density was added to the reaction solution obtained in the above step 3) at an addition rate of 1 mL/min for five minutes, and a cerium nitrate aqueous solution of 3.9 mol/L in density was added to the reaction solution at an addition rate of 1 mL/min for five minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 8: Example 8

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.13 mol/L in density was added to the reaction solution obtained in the above step 1) at an addition rate of 1 mL/min for 20 minutes, and an yttrium nitrate aqueous solution of 0.63 mol/L in density was added to the reaction solution at an addition rate of 1 mL/min for 20 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 2.2 mol/L was added to the reaction solution obtained in the above step 2) at an addition rate of 1 mL/min for 40 minutes, while the reaction solution was being heated and stirred at 90° C.

4) A cerium nitrate aqueous solution of 2.2 mol/L in density was added to the reaction solution obtained in the above step 3) at an addition rate of 1 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 9: Example 9

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.4 mol/L in density was added to the reaction solution obtained in the above step 1) at an addition rate of 1 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.5 mol/L was added to the reaction solution obtained in the above step 2) at an addition rate of 1 mL/min for 20 minutes, and the mixed solution of 2.8 mol/L in total density was added to the reaction solution at an addition rate of 1 mL/min for 20 minutes, while the reaction solution was being heated and stirred at 90° C.

4) A cerium nitrate aqueous solution of 3.7 mol/L in density was added to the reaction solution obtained in the above step 3) at an addition rate of 1 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 10: Example 10

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.4 mol/L in density was added to the reaction solution obtained in the above step 1) at an addition rate of 1 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 2.2 mol/L was added to the reaction solution obtained in the above step 2) at an addition rate of 1 mL/min for 40 minutes, while the reaction solution was being heated and stirred at 90° C.

4) A cerium nitrate aqueous solution of 3.4 mol/L in density was added to the reaction solution obtained in the above step 3) at an addition rate of 1 mL/min for five minutes, and a cerium nitrate aqueous solution of 3.9 mol/L in density was added to the reaction solution at an addition rate of 1 mL/min for five minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 11: Example 11

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.4 mol/L in density was added to the reaction solution obtained in the above step 1) at an addition rate of 1 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 2.2 mol/L was added to the reaction solution obtained in the above step 2) at an addition rate of 1 mL/min for 40 minutes, while the reaction solution was being heated and stirred at 90° C.

4) A cerium nitrate aqueous solution of 3.7 mol/L in density was added to the reaction solution obtained in the above step 3) at an addition rate of 1 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 12: Example 12

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.4 mol/L in density was added to the reaction solution obtained in the above step 1) at an addition rate of 1 mL/min for 45 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 2.2 mol/L was added to the reaction solution obtained in the above step 2) at an addition rate of 1 mL/min for 45 minutes, while the reaction solution was being heated and stirred at 90° C.

4) The precipitated abrasive material particle precursor was separated from the reaction solution obtained in the above step 3) with a membrane filter, and was then calcined at 600° C. As a result, abrasive material particles were obtained.

### Abrasive Material 13: Example 13

1) Urea was mixed with a mixed solution that was formed by mixing an yttrium nitrate aqueous solution and a cerium nitrate aqueous solution at a density ratio of 3:7 and had a total density of 0.015 mol/L, so that the density of the urea became 0.45 mol/L. The resultant solution was then heated and stirred at 90° C.

2) A mixed solution that was formed by mixing beforehand an yttrium nitrate aqueous solution and a cerium nitrate aqueous solution at a density ratio of 3:7, and had a total density of 1.6 mol/L was added to the reaction solution obtained in the above step 1) at an addition rate of 1 mL/min for 80 minutes, while the reaction solution was being heated and stirred at 90° C.

3) A cerium nitrate aqueous solution of 2.0 mol/L in density was added to the reaction solution obtained in the above step 2) at an addition rate of 1 mL/min for 10 minutes, while the reaction solution was being heated and stirred at 90° C.

4) The precipitated abrasive material particle precursor was separated from the reaction solution obtained in the above step 3) with a membrane filter, and was then calcined at 600° C.

As a result, abrasive material particles were obtained.

### Abrasive Material 14: Comparative Example 1

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 1.6 mol/L in density was added to the reaction solution obtained in the above step 1) at an addition rate of 1 mL/min for 60 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.6 mol/L was added to the reaction solution obtained in the above step 2) at an addition rate of 1 mL/min for 60 minutes, while the reaction solution was being heated and stirred at 90° C.

4) A cerium nitrate aqueous solution of 1.6 mol/L in density was added to the reaction solution obtained in the above step 3) at an addition rate of 1 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

### Abrasive Material 15: Comparative Example 2

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 1.6 mol/L in density was added to the reaction solution obtained in the above step 1) at an addition rate of 1 mL/min for 65 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 1.6 mol/L was added to the reaction solution obtained in the above step 2) at an addition rate of 1 mL/min for 65 minutes, while the reaction solution was being heated and stirred at 90° C.

4) The precipitated abrasive material particle precursor was separated from the reaction solution obtained in the above step 3) with a membrane filter, and was then calcined at 600° C. As a result, abrasive material particles were obtained.

### Abrasive Material 16: Comparative Example 3

1) Two liters of 0.02 mol/L yttrium nitrate aqueous solution were prepared, and urea was mixed with this aqueous solution so that the density of the urea became 0.60 mol/L. The resultant solution was then heated and stirred at 90° C.

2) An yttrium nitrate aqueous solution of 0.05 mol/L in density was added to the reaction solution obtained in the above step 1) at an addition rate of 30.0 mL/min for 40 minutes, while the reaction solution was being heated and stirred at 90° C.

3) A mixed solution that was formed by mixing beforehand an yttrium nitrate aqueous solution and a cerium nitrate aqueous solution at a density ratio of 3:7, and had a total density of 0.05 mol/L was added to the reaction solution obtained in the above step 2) at an addition rate of 30.0 mL/min for 40 minutes, while the reaction solution was being heated and stirred at 90° C.

4) A cerium nitrate aqueous solution of 0.05 mol/L in density was added to the reaction solution obtained in the above step 3) at an addition rate of 30.0 mL/min for 10 minutes, while the reaction solution was being heated and stirred at 90° C.

5) The precipitated abrasive material particle precursor was separated from the reaction solution obtained in the above step 4) with a membrane filter, and was then calcined at 600° C. As a result, abrasive material particles were obtained.

The experiment conditions for the above described abrasive materials 1 to 16 are shown in Table 1. In Table 1, “additive Y density”, “total additive density”, and “additive Ce density” indicate the density of yttrium contained in the added aqueous solution, the total density of yttrium and cerium, and the density of cerium, respectively. The abrasive material particles obtained in the abrasive material 12 have a two-layer structure formed with the inner layer 4 and the outer layer 5. Therefore, numerical values in the steps of forming the respective layers are shown, with the core layer forming step A being equivalent to the step of forming the inner layer 4, the intermediate layer forming step B being equivalent to the step of forming the outer layer 5. Also, the abrasive material particles obtained in the abrasive material 13 have a two-layer structure formed with the inner layer 6 and the outer layer 7. Therefore, numerical values in the steps of forming the respective layers are shown, with the intermediate layer forming step B being equivalent to the step of forming the inner layer 6, the shell layer forming step C being equivalent to the step of forming the outer layer 7.

TABLE 1

| | | | | | | | | | Intermediate layer | | | |
|---|---|---|---|---|---|---|---|---|---|---|---|---|
| | | Core layer forming step | | | | | | | forming step | | | |
| | | | | | Addition | | | | | | | Addition |
| Abrasive | Example/Comparative | Additive Y density | | | rate | Addition time | | | Total density | | | rate |
| material | Example | [mol/L] | | | [mL/min] | [min] | | | [mol/L] | | | [mL/min] |
| 1 | Example 1 | 0.05 | | | S | 40 | | | 0.05 | | | S |
| 2 | Example 2 | C | | | 1.0 | 40 | | | C | | | 1.0 |
| 3 | Example 3 | 0.13 | 0.50 | 0.80 | 1.0 | 20 | 10 | 10 | 1.0 | 2.1 | 3.2 | 1.0 |

| | | | | | | | | | |
|---|---|---|---|---|---|---|---|---|---|
| 4 | Example 4 | 0.13 | 0.63 | 1.0 | 20 | 20 | 1.5 | 2.8 | 1.0 |
| 5 | Example 5 | 0.13 | 0.63 | 1.0 | 20 | 20 | 1.5 | 2.8 | 1.0 |

| | | | | | | | | |
|---|---|---|---|---|---|---|---|---|
| 6 | Example 6 | 0.13 | 0.63 | 1.0 | 20 | 20 | 2.2 | 1.0 |

| | | | | | | | |
|---|---|---|---|---|---|---|---|
| 7 | Example 7 | 0.40 | 1.0 | 40 | 1.5 | 2.8 | 1.0 |

| | | | | | | | |
|---|---|---|---|---|---|---|---|
| Example 8 | 0.13 | 0.63 | 1.0 | 20 | 20 | 2.2 | 1.0 |

| | | | | | | | |
|---|---|---|---|---|---|---|---|
| 9 | Example 9 | 0.40 | 1.0 | 40 | 1.5 | 2.8 | 1.0 |

| | | | | | | |
|---|---|---|---|---|---|---|
| 10 | Example 10 | 0.40 | 1.0 | 40 | 2.2 | 1.0 |
| 11 | Example 11 | 0.40 | 1.0 | 40 | 2.2 | 1.0 |
| 12 | Example 12 | 0.40 | 1.0 | 45 | 2.2 | 1.0 |
| 13 | Example 13 | — | — | — | 1.6 | 1.0 |
| 14 | Comparative Example 1 | 1.60 | 1.0 | 60 | 1.6 | 1.0 |
| 15 | Comparative Example 2 | 1.60 | 1.0 | 65 | 1.6 | 1.0 |
| 16 | Comparative Example 3 | 0.05 | 30.0 | 40 | 0.05 | 30.0 |

| | | Intermediate | | | | | | | | |
|---|---|---|---|---|---|---|---|---|---|---|
| | | layer | | | | | | | | |
| | | forming | | | Shell layer forming step | | | | | Total |
| | | step | | | Additive Ce | | Addition | | | addition |
| Abrasive | Example/Comparative | Addition time | | | density | | rate | Addition time | | time |
| material | Example | [min] | | | [mol/L] | | [mL/min] | [min] | | [min] |
| 1 | Example 1 | 40 | | | 0.05 | | S | 10 | | 90 |
| 2 | Example 2 | 40 | | | C | | 1.0 | 10 | | 90 |
| 3 | Example 3 | 10 | 20 | 10 | 3.4 | 3.9 | 1.0 | 5 | 5 | 90 |

| 4 | Example 4 | 20 | 20 | 3.4 | 3.9 | 1.0 | 5 | 5 | 90 |
|---|---|---|---|---|---|---|---|---|---|
| 5 | Example 5 | 20 | 20 | 3.7 | | 1.0 | 10 | | 90 |
| 6 | Example 6 | 1.0 | | 3.4 | 3.9 | 1.0 | 5 | 5 | 90 |
| 7 | Example 7 | 20 | 1.0 | 3.4 | 3.9 | 1.0 | 5 | 5 | 90 |

| | Example 8 | 1.0 | | 2.2 | 1.0 | 10 | 90 |
|---|---|---|---|---|---|---|---|
| 9 | Example 9 | 20 | 1.0 | 3.7 | 1.0 | 10 | 90 |

| | | | | | | | | |
|---|---|---|---|---|---|---|---|---|
| 10 | Example 10 | 40 | 3.4 | 1.0 | 1.0 | 5 | 5 | 90 |

| | | | | | | |
|---|---|---|---|---|---|---|
| 11 | Example 11 | 40 | 3.7 | 1.0 | 10 | 90 |
| 12 | Example 12 | 45 | — | — | — | 90 |
| 13 | Example 13 | 80 | 2.0 | 1.0 | 10 | 90 |
| 14 | Comparative Example 1 | 60 | 1.6 | 1.0 | 10 | 130 |
| 15 | Comparative Example 2 | 65 | — | — | — | 130 |
| 16 | Comparative Example 3 | 40 | 0.05 | 30.0 | 10 | 90 |

<Evaluations of the Abrasive Materials>

The shape and the surface roughness of each of the abrasive materials 1 to 16 were evaluated by the method described below.

1. Mean Particle Size and the Variation Coefficient of the Particle Size Distribution

The mean particle size and the variation coefficient of the particle size distribution were determined from scanning electron micrograph (SEM) images of 100 abrasive material particles.

The variation coefficient of the particle size distribution was calculated according to the equation shown below.

Variation coefficient (%) of particle size distribution=(standard deviation of particle size distribution/mean particle size)×100

2. Surface Roughness After Polishing

The polishing machine used in the polishing process polishes the target surface with abrasive cloth while supplying the target surface with abrasive material slurry prepared by dispersing particles of an abrasive material using abrasive material particles in a solvent such as water. The density of the abrasive material slurry was 100 g/L, with the dispersion medium being only water. In the polishing test, polishing was performed by supplying the abrasive material slurry in a circulating manner at a flow rate of 5 L/min. The target object was a glass substrate of 65 mmφ, and the abrasive cloth was made of polyurethane. The pressure applied to the target surface at the time of polishing was 9.8 kPa (100 g/cm²), the rotating speed of the polishing tester was set at 100 min⁻¹ (rpm), and polishing was performed for 30 minutes.

The surface roughness of the glass substrate was evaluated at the atomic level with Dual channel ZeMapper, manufactured by Zygo Corporation.

<Evaluations of Polishing Performance of the Abrasive Materials>

The results obtained through the above described evaluations are shown in Table 2.

TABLE 2

| | | Mean | | |
|---|---|---|---|---|
| | | particle | Variation | Surface |
| Abrasive | Example/Comparative | size | coefficient | roughness |
| material | Example | [μm] | [%] | [nm] |
| 1 | Example 1 | 0.53 | 8 | 0.30 |
| 2 | Example 2 | 0.55 | 9 | 0.32 |
| 3 | Example 3 | 0.58 | 11 | 0.35 |
| 4 | Example 4 | 0.56 | 11 | 0.34 |
| 5 | Example 5 | 0.53 | 12 | 0.36 |
| 6 | Example 6 | 0.50 | 12 | 0.36 |
| 7 | Example 7 | 0.49 | 14 | 0.37 |
| 8 | Example 8 | 0.53 | 13 | 0.39 |
| 9 | Example 9 | 0.50 | 13 | 0.40 |
| 10 | Example 10 | 0.48 | 14 | 0.38 |
| 11 | Example 11 | 0.58 | 14 | 0.38 |
| 12 | Example 12 | 0.55 | 14 | 0.39 |
| 13 | Example 13 | 0.57 | 14 | 0.40 |
| 14 | Comparative Example 1 | 0.52 | 16 | 0.50 |
| 15 | Comparative Example 2 | 0.50 | 18 | 0.55 |
| 16 | Comparative Example 3 | 0.54 | 17 | 0.53 |

Each mean particle size (μm) was determined from SEM images of 100 abrasive material particles. Each variation coefficient was the variation coefficient of a particle size distribution determined according to the above equation.

As can be seen from Table 2, the mean particle sizes of the abrasive material particles obtained in Examples 1 to 13 of the present invention are not much different from those of Comparative Examples, but the abrasive material particles obtained in Examples 1 to 13 exhibit smaller surface roughness values than those of Comparative Examples. Accordingly, it is apparent that the abrasive material particles obtained in Examples 1 to 13 hardly damage target objects when polishing is performed.

In the abrasive material particles obtained in Examples 1 to 7, the aqueous solution densities or the aqueous solution addition rates are made to vary between layer forming steps, and the densities or the addition rates of the aqueous solutions to be added in two or more steps of the core layer forming step A, the intermediate layer forming step B, and the shell layer forming step C are also made to vary. Accordingly, the densities or the addition rates can be adjusted in accordance with particle sizes, and the surface roughness values are smaller than those of the other Examples.

In the abrasive material particles obtained in Examples 1 to 4, the aqueous solution densities or the aqueous solution addition rates are made to vary between layer forming steps, and the densities or the addition rates of the aqueous solutions to be added in the respective steps of the core layer forming step A, the intermediate layer forming step B, and the shell layer forming step C are also made to vary. Accordingly, the densities or the addition rates can be more minutely adjusted in accordance with particle sizes, and the variation coefficients and the surface roughness values are smaller than those of the other Examples.

Meanwhile, in the abrasive material particles obtained in Comparative Examples 1 to 3, the densities and the addition rates of the aqueous solutions to be added between steps and in the respective steps are not made to vary. The abrasive material particles obtained in Comparative Examples 1 and 2 require longer periods of time to grow up to the precursors having almost the same mean particle sizes as those of Examples. Also, the variation coefficients and the surface roughness values of the abrasive material particles obtained in Comparative Examples 1 and 2 are larger than those values of the abrasive material particles obtained in Examples. As for the abrasive material particles obtained in Comparative Example 3, the densities of the added aqueous solutions are the same as those of Example 1, but the addition rates are constant and are higher than those in Examples. Accordingly, almost the same mean particle size was obtained in the same total addition time as those in Examples. However, the variation coefficient of the abrasive material particles obtained in Comparative Example 3 is almost twice as large as that of Example 1, and the surface roughness value is also larger than that of Example 1.

As described above, a method of manufacturing abrasive material particles of this embodiment includes: the core layer forming step A of forming the core layer 1 as an abrasive material particle precursor by adding an aqueous solution prepared with a salt of a first element to an aqueous solution prepared with the salt of the first element at a different density, the core layer 1 containing the salt of the first element as the principal component, the first element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals: the intermediate layer forming step B of forming the intermediate layer 2 as an abrasive material particle precursor outside the core layer 1 by adding an aqueous solution prepared with a salt of a second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to the reaction solution having the core layer 1 formed therein and the salt of the first element dispersed therein, the intermediate layer 2 containing the salt of the second element and the salt of Ce; the shell layer forming step C of forming the shell layer 3 as an abrasive material particle precursor outside the intermediate layer 2 by adding an aqueous solution prepared with a salt of Ce to the reaction solution having the intermediate layer 2 formed therein and the salts of the second element and Ce dispersed therein, the shell layer 3 containing the salt of Ce as the principal component; the solid/liquid separating step D of performing solid/liquid separation to separate the abrasive material particle precursor from the reaction solution obtained through the shell layer forming step C; and the calcining step E of calcining the abrasive material particle precursor obtained in the solid/liquid separating step D in air or an oxidizing atmosphere, wherein, in the aqueous solutions from the aqueous solution to be first added in the core layer forming step A to the aqueous solution to be last added in the shell layer forming step C, the addition per unit time of the first element contained in the aqueous solution to be added in the core layer forming step A, the total addition per unit time of the second element and Ce contained in the aqueous solution to be added in the intermediate layer forming step B, and the addition per unit time of Ce contained in the aqueous solution to be added in the shell layer forming step C can be adjusted so as not to decrease, and the addition of Ce contained in the aqueous solution to be last added in the shell layer forming step C can be increased compared with the addition of the first element contained in the aqueous solution to be first added in the core layer forming step A. Accordingly, the usage of cerium oxide can be restricted while the growth rate of the particle size of abrasive material particles is controlled in accordance with the particle size of target abrasive material particles, and abrasive material particles that exhibit higher durability and a higher polishing rate can be efficiently manufactured.

As for the aqueous solutions to be added in at least one step of the core layer forming step A, the intermediate layer forming step B, and the shell layer forming step C, the total addition of the additive elements contained in the aqueous solution to be last added in the one step is increased compared with the total addition of the additive elements contained in the aqueous solution to be first added in the one step. Accordingly, the growth rate of the particle size can be controlled in each layer forming step.

The total addition of the second element and Ce contained in the aqueous solution to be first added in the intermediate layer forming step B is increased compared with the addition of the first element contained in the aqueous solution to be last added in the core layer forming step A. Accordingly, the abrasive material particle precursor that has grown to a predetermined particle size through the core layer forming step A can be more efficiently grown as particles.

The addition of Ce contained in the aqueous solution to be first added in the shell layer forming step Cis increased compared with the total addition of the second element and Ce contained in the aqueous solution to be last added in the intermediate layer forming step B. Accordingly, the abrasive material particle precursor that has grown to a predetermined particle size through the intermediate layer forming step B can be more efficiently grown as particles.

The total addition per unit time of the additive elements contained in the aqueous solution to be added in at least one step of the core layer forming step A, the intermediate layer forming step B, and the shell layer forming step C is increased as the reaction time passes. Accordingly, the reaction can be made to progress slowly, and the particle size that becomes larger with time can be made efficiently grown.

The addition per unit time of the first element contained in the aqueous solution to be added in the core layer forming step A, the total addition per unit time of the second element and Ce contained in the aqueous solution to be added in the intermediate layer forming step B, and the addition per unit time of Ce contained in the aqueous solution to be added in the shell layer forming step C are adjusted in accordance with the densities or the addition rates of the aqueous solutions. Accordingly, the additions can be appropriately changed so as to facilitate preparation of the aqueous solutions, and an abrasive material particle precursor can be efficiently grown.

In this embodiment, the intermediate layer 2 that can form an excellent abrasive material can be formed, and accordingly, the ratio between yttrium and cerium contained in the aqueous solution to be added in the intermediate layer forming step B is 3:7 in many of the above described examples. However, this ratio is merely an example, and can be changed as appropriate. As the methods of adding aqueous solutions, example density variation techniques of I. increase in one step, II. increase between steps, and III. temporal increase have been described above. However, one of these techniques may be used, or these techniques may be appropriately combined as shown in Examples.

### INDUSTRIAL APPLICABILITY

The present invention can be used in performing polishing with an abrasive material containing cerium oxide in the process of manufacturing a glass product, a semiconductor device, a crystal oscillator, or the like.

### REFERENCE SIGNS LIST

1 Core layer

2 Intermediate layer

3 Shell layer

4 Inner layer

5 Outer layer

6 Inner layer

7 Outer layer

A Core layer forming step

B Intermediate layer forming step

C Shell layer forming step

D Solid/liquid separating step

E Calcining step

1.-8. (canceled)

9. A method of manufacturing abrasive material particles, comprising:
a core layer forming step of forming a core layer as an abrasive material particle precursor by adding an aqueous solution prepared with a salt of a first element to an aqueous solution prepared with the salt of the first element at a different density, the core layer containing the salt of the first element as a principal component, the first element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals:
an intermediate layer forming step of forming an intermediate layer as an abrasive material particle precursor outside the core layer by adding an aqueous solution prepared with a salt of a second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to a reaction solution having the core layer formed therein and the salt of the first element dispersed therein, the intermediate layer containing the salt of the second element and the salt of Ce;
a shell layer forming step of forming a shell layer as an abrasive material particle precursor outside the intermediate layer by adding an aqueous solution prepared with a salt of Ce to a reaction solution having the intermediate layer formed therein and the salts of the second element and Ce dispersed therein, the shell layer containing the salt of Ce as a principal component;
a solid/liquid separating step of performing solid/liquid separation to separate the abrasive material particle precursor from a reaction solution obtained through the shell layer forming step; and
a calcining step of calcining the abrasive material particle precursor obtained in the solid/liquid separating step in air or an oxidizing atmosphere,
wherein,
in aqueous solutions from the aqueous solution to be first added in the core layer forming step to the aqueous solution to be last added in the shell layer forming step, an addition per unit time of the first element contained in the aqueous solution to be added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted so as not to decrease, and
an addition of Ce contained in the aqueous solution to be last added in the shell layer forming step is increased compared with an addition of the first element contained in the aqueous solution to be first added in the core layer forming step.

10. The method of manufacturing abrasive material particles according to claim 9, wherein, in aqueous solutions to be added at least in one step of the core layer forming step, the intermediate layer forming step, and the shell layer forming step, a total addition of additive elements contained in the aqueous solution to be last added in the one step is increased compared with a total addition of additive elements contained in the aqueous solution to be first added in the one step.

11. The method of manufacturing abrasive material particles according to claim 9, wherein a total addition of the second element and Ce contained in the aqueous solution to be first added in the intermediate layer forming step is increased compared with an addition of the first element contained in the aqueous solution to be last added in the core layer forming step.

12. The method of manufacturing abrasive material particles according to claim 9, wherein an addition of Ce contained in the aqueous solution to be first added in the shell layer forming step is increased compared with a total addition of the second element and Ce contained in the aqueous solution to be last added in the intermediate layer forming step.

13. The method of manufacturing abrasive material particles according to claim 9, wherein a total addition per unit time of additive elements contained in aqueous solutions to be added in at least one step of the core layer forming step, the intermediate layer forming step, and the shell layer forming step is increased as a reaction time passes.

14. The method of manufacturing abrasive material particles according to claim 9, wherein an addition per unit time of the first element contained in the aqueous solution to the added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted in accordance with densities or addition rates of the respective aqueous solutions.

15. A method of manufacturing abrasive material particles, comprising:
an inner layer forming step of forming an inner layer as an abrasive material particle precursor by adding an aqueous solution prepared with a salt of a first element to an aqueous solution prepared with the salt of the first element at a different density, the inner layer containing the salt of the first element as a principal component, the first element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals:
an outer layer forming step of forming an outer layer as an abrasive material particle precursor outside the inner layer by adding an aqueous solution prepared with a salt of a second element formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals, and a salt of Ce, to a reaction solution having the inner layer formed therein and the salt of the first element dispersed therein, the outer layer containing the salt of the second element and the salt of Ce;
a solid/liquid separating step of performing solid/liquid separation to separate the abrasive material particle precursor from a reaction solution obtained through the outer layer forming step; and
a calcining step of calcining the abrasive material particle precursor obtained in the solid/liquid separating step in air or an oxidizing atmosphere,
wherein,
in aqueous solutions from the aqueous solution to be first added in the inner layer forming step to the aqueous solution to be last added in the outer layer forming step, an addition per unit time of the first element contained in the aqueous solution to be added in the inner layer forming step and a total addition per unit time of the second element and Ce contained in the aqueous solution to be added in the outer layer forming step are adjusted so as not to decrease, and
a total addition of the second element and Ce contained in the aqueous solution to be last added in the outer layer forming step is increased compared with an addition of the first element contained in the aqueous solution to be first added in the inner layer forming step.

16. A method of manufacturing abrasive material particles, comprising:
an inner layer forming step of forming an inner layer as an abrasive material particle precursor by adding an aqueous solution prepared with a salt of an element and a salt of Ce to an aqueous solution prepared with the salt of the element and the salt of Ce at a different density, the inner layer containing the salt of the element and the salt of Ce, the element being formed with at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkaline earth metals;
an outer layer forming step of forming an outer layer as an abrasive material particle precursor outside the inner layer by adding an aqueous solution prepared with a salt of Ce to a reaction solution having the inner layer formed therein and the salts of the element and Ce dispersed therein, the outer layer containing the salt of Ce as a principal component;
a solid/liquid separating step of performing solid/liquid separation to separate the abrasive material particle precursor from a reaction solution obtained through the outer layer forming step; and
a calcining step of calcining the abrasive material particle precursor obtained in the solid/liquid separating step in air or an oxidizing atmosphere,
wherein,
in aqueous solutions from the aqueous solution to be first added in the inner layer forming step to the aqueous solution to be last added in the outer layer forming step, a total addition per unit time of the element and Ce contained in the aqueous solution to be added in the inner layer forming step and an addition per unit time of Ce contained in the aqueous solution to be added in the outer layer forming step are adjusted so as not to decrease, and
an addition of Ce contained in the aqueous solution to be last added in the outer layer forming step is increased compared with a total addition of the element and Ce contained in the aqueous solution to be first added in the inner layer forming step.

17. The method of manufacturing abrasive material particles according to claim 10, wherein a total addition of the second element and Ce contained in the aqueous solution to be first added in the intermediate layer forming step is increased compared with an addition of the first element contained in the aqueous solution to be last added in the core layer forming step.

18. The method of manufacturing abrasive material particles according to claim 10, wherein an addition of Ce contained in the aqueous solution to be first added in the shell layer forming step is increased compared with a total addition of the second element and Ce contained in the aqueous solution to be last added in the intermediate layer forming step.

19. The method of manufacturing abrasive material particles according to claim 10, wherein a total addition per unit time of additive elements contained in aqueous solutions to be added in at least one step of the core layer forming step, the intermediate layer forming step, and the shell layer forming step is increased as a reaction time passes.

20. The method of manufacturing abrasive material particles according to claim 10, wherein an addition per unit time of the first element contained in the aqueous solution to the added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted in accordance with densities or addition rates of the respective aqueous solutions.

21. The method of manufacturing abrasive material particles according to claim 11, wherein a total addition per unit time of additive elements contained in aqueous solutions to be added in at least one step of the core layer forming step, the intermediate layer forming step, and the shell layer forming step is increased as a reaction time passes.

22. The method of manufacturing abrasive material particles according to claim 11, wherein an addition per unit time of the first element contained in the aqueous solution to the added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted in accordance with densities or addition rates of the respective aqueous solutions.

23. The method of manufacturing abrasive material particles according to claim 12, wherein a total addition per unit time of additive elements contained in aqueous solutions to be added in at least one step of the core layer forming step, the intermediate layer forming step, and the shell layer forming step is increased as a reaction time passes.

24. The method of manufacturing abrasive material particles according to claim 12, wherein an addition per unit time of the first element contained in the aqueous solution to the added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted in accordance with densities or addition rates of the respective aqueous solutions.

25. The method of manufacturing abrasive material particles according to claim 13, wherein an addition per unit time of the first element contained in the aqueous solution to the added in the core layer forming step, a total addition per unit time of the second element and Ce contained in the aqueous solution to be added in the intermediate layer forming step, and an addition per unit time of Ce contained in the aqueous solution to be added in the shell layer forming step are adjusted in accordance with densities or addition rates of the respective aqueous solutions.
